(19) United States
(12) Patent Application Publication
(10) Pub. No.: US 2017/0145246 A1
(43) Pub. Date: May 25, 2017

(54) PAINTED ARTICLE COATED WITH COATING PAINT COMPOSITION FOR POLYCARBONATE GLAZING

(71) Applicants: Hyundai Motor Company, Seoul (KR); NOROO Holdings Co., Ltd., Anyang (KR); NOROOBEE Chemical Co., Ltd., Cheonan (KR)

(72) Inventors: Duck-Hyoung Hwang, Seoul (KR); Yong-Bum Lee, Seoul (KR); Young-Hee Jung, Cheonan (KR); Jae-Beom Ahn, Anyang (KR); Young-Hoon Choi, Cheonan (KR); Min-Kyu Jung, Busan (KR); Jung-Il Kong, Anyang (KR); Tae-Kyun Kim, Anyang (KR)

(21) Appl. No.: 15/078,127

(22) Filed: Mar. 23, 2016

(30) Foreign Application Priority Data
Nov. 20, 2015 (KR) 10-2015-0163069

(51) Int. Cl. C09D 133/12; C09D 133/14

(52) U.S. Cl. CPC C09D 133/12; C09D 133/14; C08K 5/3435

(57) ABSTRACT

Disclosed is a polycarbonate article coated with a coating composition for glazing, and in particular, the polycarbonate article coated with the coating composition may have an adhesion property with a material made of polycarbonate, thereby protecting the material made of polycarbonate from ultraviolet rays and the like. In addition, among the coating composition, a primer layer from the coating composition may be applied on the material made of polycarbonate may provide and a hard coating layer painted on the primer layer, thereby providing abrasion resistance. The polycarbonate article of the present invention comprises a polycarbonate panel; a primer layer applied on the panel; and a hard coating layer applied on the primer layer.

### CROSS-REFERENCE TO RELATED APPLICATIONS

This application claims priority under 35 U.S.C. §119 to Korean Patent Application No. 10-2015-0163069, filed on Nov. 20, 2015, in the Korean Intellectual Property Office, the disclosure of which is incorporated herein by reference in its entirety.

### TECHNICAL FIELD

The present invention relates to a painted polycarbonate article coated with a coating paint composition for glazing. The coating paint composition for polycarbonate glazing may have an adhesion property to a base material such as polycarbonate and the coating paint composition can protect the article from ultraviolet rays and the like. In addition, the painted article may have abrasion resistance obtained from a primer layer directly applied on the material made of polycarbonate and a hard coating layer painted on the primer layer.

### BACKGROUND

A transparent thermoplastic plastic has a light weight and is easily shaped, and safety, style, and other merits thereof have been known over a long period of time. Because of these merits, the transparent thermoplastic plastics have been used to replace glass in many fields. Among the plastics, polycarbonate having excellent physical properties such as heat and impact resistances and excellent strength and optical transparency has been used in glasses of buildings, trains, and vehicles, lenses of eyeglasses, soundproof walls, and the like, and application of the polycarbonate has been gradually increased.

Recently, a weight reduction of vehicles and the resulting improvement of fuel efficiency have become a major issue in a vehicle industry field, and thus an interest in replacing glass with plastic materials has been further increased. Generally, when the glass applied to the vehicle is replaced with the plastic, the weight of the vehicle can be reduced to improve fuel efficiency of the vehicle. In addition, when the glass used in a sunroof of the vehicle is replaced with the plastic, a weight of the roof of the vehicle can be reduced to move the center of gravity of the vehicle downward, and the low center of gravity can improve stability when the vehicle is driven and turned.

However, polycarbonate has many problems as compared to the glass. These problems are caused by running of the vehicle. For instance, polycarbonate physically or chemically deteriorates when exposed to an extreme temperature and environment, strong and continuous vibration force transferred while the vehicle is generally driven, an intermittently occurring strong impact, an impact load that may cause scratches on a surface by collision of dust or other particles or contact by car washing and the like, and exposure to environmental factors, such as rain and ultraviolet rays and infrared rays of rays of the sun, over a long period of time. Moreover, polycarbonate has a drawback in that abrasion resistance and weather resistance thereof are inferior than those of the glass. Therefore, action for improving the abrasion resistance and the weather resistance of polycarbonate has been taken in order to solve these problems, but significant effect has not been shown.

In order to solve the aforementioned problems, in the related art, polycarbonate has been coated with a soluble hard coat including a silane-containing oligomer, silane having the Chemical Formula of R³_{c}SiX_{(4-d)}, metal oxide, and a silane-containing oligomer including a condensation catalyst. However, since paint storability at room temperature is not improved, the temperature should be maintained at 10° C. or less during working and storage. Further, in the related art, a plastic glazing system constituted by a first weather resistant layer including one of polyurethane and polyurethane-acrylate and a first wear resistant layer compoundable with one of polyurethane and polyurethane-acrylate has been reported. However, the first wear resistant layer is obtained by using a plasma enhanced chemical vapor deposition method (PECVD) and may not be implemented by a general painting method.

Therefore, the present invention provides forming a coating layer on polycarbonate to improve the abrasion resistance and the weather resistance of the polycarbonate.

### SUMMARY OF THE INVENTION

In preferred aspects, the present provides a painted article coated with a coating paint composition for polycarbonate glazing, such that abrasion resistance and weather resistance of polycarbonate may be improved.

In addition, the painted article coated with the coating paint composition for polycarbonate glazing may be used to replace glass applied to a vehicle to thereby reduce a weight of the vehicle and increase fuel efficiency of the vehicle.

Technical objects of the present invention are not limited to the technical objects described above, and other technical objects that are not described will be clearly understood by a person skilled in the art from the description below.

In one aspect of the present invention, provided is a polycarbonate article which may be transparent and may be used as a transparent substance panel of, for example, a vehicle.

The polycarbonate article may be formed of a base material that may comprise polycarbonate and derivatives thereof, which may be transparent or not. The polycarbonate article may be formed in any desired shape, for example, by molding, thermoforming and the like as generally used in the related art, and preferably, the polycarbonate article may be further processed or manipulated by, for example, painting or coating with a coating composition as described herein.

The term “transparent” as used herein refers to an optical property having a light transmittance greater than about 50%, about 60%, about 70%, about 80%, about 90% or about 95% at visible (naked eyes) light wavelengths.

In addition, the “coating” or the “coating composition” refers to any material or substance that can be applied or coated on the surface of the base polycarbonate, e.g. polycarbonate panel, in a form of thin film, for example, having a thickness less than about 10 mm, less than about 1 mm, less than about 100 μm, less than about 50 μm or less than about 10 μm. The coating may be applied at least one time, at least two times, at least three times, at least four times, or at least five times until desired thickness is obtained. The coating or the coating composition according to the present invention may be multiple layers of same or different layers, for example, the coating composition applied on the polycarbonate base material may include at least a primer layer and a hard coating layer. Exemplary coating procedures include, for example, flow coating, dip coating, and spray coating.

In an exemplary embodiment, the polycarbonate glazing painted article may comprise: a polycarbonate panel; a primer layer applied on the panel; and a hard coating layer applied on the primer layer. In particular, the primer layer may have an adhesion property and block ultraviolet rays, and the hard coating layer may provide abrasion resistance.

The term “panel”, as used herein, refers to a component formed of base material, e.g. polycarbonate base material, which may have a planar or curved surface shape and can be used as surface or covering material. However, the panel of the present invention may not be limited to those functions, any shapes and sizes thereof.

The primer layer may comprise an acryl resin compound in an amount of about 25 to 33 parts by weight, a UV stabilizer in an amount of about 1.5 to 3 parts by weight, a leveling additive in an amount of about 0.1 to 0.3 parts by weight, and a first organic solvent in an amount of about 65 to 75 parts by weight. All the parts by weights of these components are Preferably based on the total weight of the primer layer.

The UV stabilizer may comprise: one or more of TINUVIN® 400, HOSTAVIN® 3051, HOSTAVIN® 3206, HOSTAVIN® 3330, HOSTAVIN® 3052, HOSTAVIN® 3058, HOSTAVIN® N30, HOSTAVIN® PR-31, HOSTAVIN® TB 01, HOSTAVIN® TB 02, HOSTAVIN® AR08, HOSTAVIN® VSU 3206, HOSTAVIN® 3206, and HOSTAVIN® 3065.

Preferably, the leveling additive may not affect an interlayer adhesion property of the primer layer with hard coating, and may be a silicon-based leveling additive or a non-silicon-based leveling additive.

Preferably, the acryl resin compound may comprise a reaction mixture obtainable from the following reagents: an acryl monomer not containing a hydroxy group in an amount of about 17 to 23 parts by weight, an acryl monomer containing a hydroxy group in an amount of about 2 to 5 parts by weight, an initiator in an amount of about 0.1 to 0.5 parts by weight, and a second organic solvent in an amount of about 70 to 80 parts by weight. All the parts by weights of these components are based on the total weight of the reaction mixture that may be employed to produce an acryl resin compound.

Preferably, the acryl monomer not containing the hydroxy group may comprise one or more acryl groups, and comprise one or more selected from the group consisting of a styrene monomer, methyl methacrylate, ethyl methacrylate, butyl methacrylate, methyl acrylate, ethyl acrylate, n-butyl acrylate, an acrylic acid, and a methacrylic acid.

Preferably, the acryl monomer containing the hydroxy group may comprise one or more selected from the group consisting of 2-hydroxyethyl acrylate, 2-hydroethyl methacrylate, and 2-hydroxypropyl acrylate.

The hard coating layer may comprise: an acryl-urethane silica compound in an amount of about 23 to 36 parts by weight, a silane coupling agent containing an alkyl group in an amount of about 3 to 10 parts by weight, a silane coupling agent containing an alkoxy group in an amount of about 10 to 25 parts by weight, a silica sol in an amount of about 23 to 40 parts by weight, an alcohol-based solvent in an amount of about 15 to 25 parts by weight, water in an amount of about 5 to 15 parts by weight, and an acid stabilizer in an amount of about 0.01 to 0.3 parts by weight. All the parts by weights of the components are based on the total weight of the hard coating layer.

Preferably, the silane coupling agent containing the alkyl group may comprise one or more selected from the group consisting of a methyl group, an ethyl group, and a propyl group, and comprise any one selected from the group consisting of methyltrichlorosilane, methyltrimethoxysilane, methyltriethoxysilane, methyltributoxysilane, ethyltrimethoxysilane, ethyltriisopropoxysilane, ethyltributoxysilane, butyltrimethoxysilane, dimethyldiaminosilane, dimethyldichlorosilane, dimethyldiacetoxysilane, dimethyldimethoxysilane, dibutyldimethoxysilane, trimethylchlorosilane, and methyltris(3-methyl-3-oxetanemethoxy)silane.

Preferably, the silane coupling agent containing the alkoxy group may comprise four or more alkoxy groups, such as methoxy and ethoxy, and comprise one or more selected from the group consisting of tetramethoxysilane, tetraethoxysilane, tetrapropoxysilane, tetraisopropoxysilane, and hexaethoxydisilane.

Preferably, the alcohol-based solvent may comprise one or more of selected from the group consisting methyl alcohol, ethyl alcohol, isopropyl alcohol, 2-methoxy ethanol, 2-ethoxy ethanol, and 2-butoxy ethanol.

The acid stabilizer may be an organic acid, an inorganic acid, or a mixture thereof.

Preferably, the organic acid may comprise one or more selected from the group consisting of a formic acid, an acetic acid, a propionic acid, a butyric acid, a lactic acid, a citric acid, and a fumaric acid, and the inorganic acid may comprise one or more selected from the group consisting of a phosphoric acid, a sulfuric acid, a hydrochloric acid, a nitric acid, a hydrofluoric acid, a chlorosulfonic acid, a p-toluenesulfonic acid, a trichloroacetic acid, a polyphosphoric acid, an iodic acid, an iodic anhydride, and a perchloric acid.

Preferably, the acryl-urethane silica compound may comprise a silane coupling agent containing isocyanate in an amount of about 3 to 10 parts by weight, an acryl monomer containing a hydroxy group in an amount of about 3 to 10 parts by weight, an acryl monomer not containing a hydroxy group in an amount of about 20 to 30 parts by weight, an initiator in an amount of about 0.1 to 2 parts by weight, an organic metal catalyst in an amount of about 0.01 to 0.05 parts by weight, and a third organic solvent in an amount of about 50 to 60 parts by weight, all the parts by weights of the component are based on the total weight of the acryl-urethane silica compound.

Preferably, the silane coupling agent containing isocyanate may comprise one or more isocyanates, and may comprise one or more selected from the group consisting of 3-isocyanatepropyltrimethoxysilane, 3-isocyanatepropyltriethoxysilane, methoxytriisocyanatesilane, Y-isocyanatepropyltrimethoxysilane, and tetraisocyanatesilane.

Preferably, the acryl monomer containing the hydroxy group may comprise one or more selected from the group consisting of 2-hydroxyethyl acrylate, 2-hydroethyl methacrylate, and 2-hydroxypropyl acrylate.

Preferably, the acryl monomer not containing the hydroxy group may comprise one or more acryl groups, and may comprise one or more selected from the group consisting of a styrene monomer, methyl methacrylate, ethyl methacrylate, butyl methacrylate, methyl acrylate, ethyl acrylate, n-butyl acrylate, an acrylic acid, and a methacrylic acid.

Preferably, the polycarbonate panel may be transparent such that that can be used as a transparent panel of a vehicle.

Further provided is the present invention a vehicle part that may comprise the polycarbonate article as described herein.

Accordingly, the polycarbonate article coated with the coating paint composition as described herein for glazing, a weather resistance and a abrasion resistance of the material can be improved and workability may be excellent, and thus various types of painting methods such as flow coating, dip coating, and spray coating can be applied thereto. In addition, cold storage may not be necessary, and thus storability of the paint composition for hard coating can be improved. Further, because storability of a hard coating solution is improved, the paint from the coating composition or primer layer composition may be collected and reused repetitively to thereby reduce cost.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, various exemplary embodiments of the present invention will be described in detail with reference to the accompanying drawings. Terms or words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Accordingly, the embodiment described in the present specification and the constitution illustrated in the drawings are just the most preferred embodiment of the present invention but do not represent all technical spirits of the present invention. Therefore, it should be understood that there are various equivalents and modifications replacing the embodiments at the time of filing of the present application.

A polycarbonate article coated with a coating composition for glazing according to the present invention may have improved abrasion resistance and a weather resistance of polycarbonate and the like. The coating composition may comprise a primary layer and a hard coating layer. For instance, the polycarbonate article may include a primer layer directly that may be applied on a polycarbonate material to have a material adhesion property and may serve to protect the material from ultraviolet rays and the like, and a hard coating layer painted on the primer layer to provide the abrasion resistance.

The primer layer may comprise an acryl resin compound, a UV stabilizer, a leveling additive, and a first organic solvent. Further, the acryl resin compound may include (1) an acryl monomer not containing hydroxy group, (2) an acryl monomer containing hydroxy group, (3) an initiator, and (4) a first organic solvent.

Hereinafter, each component of the acryl resin compound will be specifically reviewed.

### (1) Acryl Monomer not Containing Hydroxy Group

The acryl monomer that does not contain hydroxy group may serve to attain an appropriate viscosity in an acryl reaction. The content of the acryl monomer not containing hydroxy group may range from about 17 to about 23 parts by weight based on the total weight of the acryl resin compound. Herein, when the content of the acryl monomer not containing the hydroxy group is less than about 17 parts by weight or greater than about 23 parts by weight, during the acryl reaction, the appropriate viscosity may not be attained or compatibility may be poor.

The acryl monomer not containing the hydroxy group may essentially include one or more acryl groups such as methyl acrylate and methyl methacrylate. The acryl monomer not containing the hydroxy group may include, but not be limited to, a styrene monomer, methyl methacrylate, ethyl methacrylate, butyl methacrylate, methyl acrylate, ethyl acrylate, n-butyl acrylate, an acrylic acid, a methacrylic acid, and the mixtures thereof.

### (2) Acryl Monomer Containing Hydroxy Group

The acryl monomer containing the hydroxy group may improve an adhesion property between polycarbonate and the primer layer. The content of the acryl monomer containing the hydroxy group may range from about 2 to about 5 parts by weight based on the total weight of the acryl resin compound. Herein, when the content of the acryl monomer including the hydroxy group is less than about 2 parts by weight, the acryl monomer may not obtain sufficient adhesion property as being included in the primer layer, and when the content of the acryl monomer including the hydroxy group is greater than about 5 parts by weight, storability may become poor.

The acryl monomer containing the hydroxy group may include, but not be limited to, 2-hydroxyethyl acrylate, 2-hydroethyl methacrylate, 2-hydroxypropyl acrylate, and the mixtures thereof.

### (3) Initiator (First Initiator)

The first initiator may initiate a polymerization reaction of the monomer. The content of the initiator may range from about 0.1 to about 0.5 parts by weight, based on the total weight of the acryl resin compound. Herein, when the content of the initiator is less than about 0.1 parts by weight, the polymerization reaction of the monomer may not be sufficient, and when the content of the initiator is greater than about 0.5 parts by weight, a molecular weight of the thus formed polymer, e.g. polyacryl, may be reduced due to an excessive use of the polymerization initiator.

### (4) Organic Solvent (First Organic Solvent)

The first organic solvent as being included in the acryl resin compound may be used to uniformly perform the polymerization reaction of the acryl resin. In The content of the organic solvent may range from about 70 to about 80 parts by weight based on the total weight of the acryl resin compound. Herein, when the content of the organic solvent is less than about 70 parts by weight or greater than about 80 parts by weight, the polymerization reaction of the acryl resin may not be uniformly performed.

The primer layer of the present invention includes (1) the above acryl resin compound, (2) an UV stabilizer, (3) a leveling additive, and (4) a second organic solvent. Hereinafter, each component of the primer layer will be specifically reviewed.

### (1) Acryl Resin Compound

The acryl resin compound, as used herein, may increase the adhesion property between polycarbonate and the hard coating layer. The content is 25 to 33 parts by weight based on the total weight of the primer layer or primer layer composition. Herein, when the content of the acryl resin compound is less than about 25 parts by weight, the adhesion property between the hard coating layer and the material may be reduced, and when the content of the acryl resin compound is greater than about 33 parts by weight, transparency and compatibility may be reduced.

### (2) UV Stabilizer

The UV stabilizer, as used herein, may attain the weather resistance by ultraviolet rays and the like. The content of the UV stabilizer may range from about 1.5 to about 3 parts by weight based on the total weight of the primer layer or primer layer composition. Herein, when the content of the UV stabilizer is less than about 1.5 parts by weight, the weather resistance to the ultraviolet rays and the like may not be sufficient, and when the content of the UV stabilizer is greater than about 3 parts by weight, compatibility with the acryl resin may not be attained.

It would be appreciated that the UV stabilizer may be provided with TINUVIN® 400, HOSTAVIN® 3051, HOSTAVIN® 3206, HOSTAVIN® 3330, HOSTAVIN® 3052, HOSTAVIN® 3058, HOSTAVIN® N30, HOSTAVIN® PR-31, HOSTAVIN® TB 01, HOSTAVIN® TB 02, HOSTAVIN® AR08, HOSTAVIN® VSU 3206, HOSTAVIN® 3206, HOSTAVIN® 3065, and the mixtures thereof.

### (3) Leveling Additive

The leveling additive, as used herein, may prevent paint agglomeration in coating and the like and thus increase workability. The content of the leveling additive may range from about 0.1 to about 0.3 parts by weight based on the total weight of the primer layer or primer layer composition. Herein, when the content of the leveling additive is less than about 0.1 parts by weight, workability may be reduced due to paint agglomeration caused by a leveling lack in coating, and when the content of the leveling additive is greater than about 0.3 parts by weight, appearance defects such as cratering may occur.

The leveling additive may include, but not be limited to, a silicon-based leveling additive or a non-silicon-based leveling additive. In particular, the leveling additive that does not affect an interlayer adhesion property between the primer layer and the hard coating layer may be preferably used.

### (4) Organic Solvent (Second Organic Solvent)

The second organic solvent, as being included in the primer layer herein, may increase compatibility between the acryl resin compound and the UV stabilizer. The content of the second organic solvent may range from about 65 to about 75 parts by weight based on the total weight of the primer layer or primer layer composition. Herein, when the content of the second organic solvent is less than about 65 parts by weight or greater than 75 parts by weight, compatibility between the acryl resin compound and the UV stabilizer may not be sufficient.

The hard coating layer may comprise an acryl-urethane silica compound, a silane coupling agent containing an alkyl group, a silane coupling agent containing an alkoxy group, a silica sol, an alcohol-based solvent, water, and an acid stabilizer. Further, the acryl-urethane silica compound may comprise (1) a silane coupling agent containing isocyanate, (2) an acryl monomer containing hydroxy group, (3) an acryl monomer not containing hydroxy group, (4) an initiator, (5) an organic metal catalyst, and (6) a third organic solvent.

Hereinafter, each component of the acryl-urethane silica compound will be specifically reviewed.

### (1) Silane Coupling Agent Containing Isocyanate

The silane coupling agent containing isocyanate may effectively bond the organic resin and the inorganic resin. The content of the silane coupling agent containing isocyanate may range from about 3 to about 10 parts by weight based on the total weigh of the acryl-urethane silica compound. Herein, when the content of the silane coupling agent containing isocyanate is less than about 3 parts by weight, the organic resin and the inorganic resin may not be sufficiently bonded and an organic-inorganic complex property may not be attained. When the content of the silane coupling agent containing isocyanate is greater than about 10 parts by weight, storage stability may not be sufficiently attained due to excessiveness of the silane coupling agent containing isocyanate.

The silane coupling agent containing isocyanate may include one or more isocyanates. The silane coupling agent containing isocyanate may include, but not be limited to, 3-isocyanatepropyltrimethoxysilane, 3-isocyanatepropyltriethoxysilane, methoxytriisocyanatesilane, Y-isocyanatepropyltrimethoxysilane, tetraisocyanatesilane, and the mixtures thereof.

### (2) Acryl Monomer Containing Hydroxy Group

The acryl monomer containing the hydroxy group may be used to effectively perform a reaction with the silane coupling agent containing isocyanate. The content of the acryl monomer including the hydroxy group may range from about 3 to about 10 parts by weight based on the total weigh of the acryl-urethane silica compound. Herein, when the content of the acryl monomer including the hydroxy group is less than about 3 parts by weight or greater than about 10 parts by weight, the acryl monomer containing hydroxy group may not be sufficiently reacted with the silane coupling agent containing isocyanate and the organic-inorganic complex property may not be attained.

The acryl monomer containing hydroxy group may include 2-hydroxyethyl acrylate, 2-hydroethyl methacrylate, 2-hydroxypropyl acrylate, and the mixtures thereof.

### (3) Acryl Monomer not Containing Hydroxy Group

The acryl monomer not containing hydroxy group may be used to attain an appropriate viscosity and compatibility in an organic-inorganic complex reaction. The content of the acryl monomer not containing hydroxy group may range from about 20 to about 30 parts by weight based on the total weigh of the acryl-urethane silica compound. Herein, when the content of the acryl monomer not containing hydroxy group is less than about 20 parts by weight or greater than about 30 parts by weight, the appropriate viscosity, compatibility, and the like may not be attained in the organic-inorganic complex reaction.

The acryl monomer not containing hydroxy group may essentially include one or more acryl groups like methyl acrylate and methyl methacrylate. The acryl monomer not containing hydroxy group may include, but not be limited to, a styrene monomer, methyl methacrylate, ethyl methacrylate, butyl methacrylate, methyl acrylate, ethyl acrylate, n-butyl acrylate, an acrylic acid, a methacrylic acid, and the mixtures thereof.

### (4) Initiator (Second Initiator)

The second initiator, as used herein, may initiate a polymerization reaction of the monomer. The content of the initiator may range from about 0.1 to about 2 parts by weight based on the total weigh of the acryl-urethane silica compound. Herein, when the content of the initiator is less than about 0.1 parts by weight, the polymerization reaction of the monomer may not be sufficient, and when the content of the initiator is greater than about 2 parts by weight, a molecular weight of the formed polymer, e.g. acryl-urethane silica compound, may be reduced due to an excessive use of the polymerization initiator.

### (5) Organic Metal Catalyst

The organic metal catalyst may reduce activation energy of the reaction. The content of the organic metal catalyst may range from about 0.01 to about 0.05 parts by weight based on the total weigh of the acryl-urethane silica compound. Herein, when the content of the organic metal catalyst is less than about 0.01 parts by weight or greater than about 0.05 parts by weight, the reaction may not occur smooth.

### (6) Organic Solvent (Third Organic Solvent)

The third organic solvent as being included in the acryl-urethane silica compound, may be used to make the reaction uniform. The content of the third organic solvent may range from about 50 to 60 parts by weight based on the total weigh of the acryl-urethane silica compound. Herein, when the content of the third organic solvent is less than about 50 parts by weight or greater than about 60 parts by weight, the reaction of the acryl-urethane silica compound may not uniformly be performed.

The hard coating layer of the present invention includes (1) the above acryl-urethane silica compound, (2) a silane coupling agent containing alkyl group, (3) a silane coupling agent containing alkoxy group, (4) a silica sol, (5) an alcohol-based solvent, (6) water, and (7) an acid stabilizer. Hereinafter, each component of the hard coating layer will be specifically reviewed.

### (1) Acryl-Urethane Silica Compound

The acryl-urethane silica compound, as used herein, may increase an adhesion property of the organic-inorganic complex coating composition for hard coating. The content of the acryl-urethane silica compound may range from about 23 to about 36 parts by weight based on the total weight of the hard coating layer. Herein, when the content of the acryl-urethane silica compound is less than about 23 parts by weight, physical properties such as attachment of the organic-inorganic complex coating composition for hard coating may be reduced, and when the content of the acryl-urethane silica compound is greater than about 36 parts by weight, transparency and compatibility may be reduced.

### (2) Silane Coupling Agent Containing Alkyl Group

The silane coupling agent containing alkyl group, as used herein, may increase complexation compatibility and the degree of reaction crosslinking of an organic component and an inorganic component of the organic-inorganic complex coating composition for hard coating. The content of the silane coupling agent containing the alkyl group may range from about 3 to about 10 parts by weight based on the total weight of the hard coating layer. Herein, when the content of the silane coupling agent containing the alkyl group is less than about 3 parts by weight or greater than about 10 parts by weight, complexation compatibility and the degree of reaction crosslinking of the organic component and the inorganic component of the organic-inorganic complex coating composition for hard coating may be reduced.

The silane coupling agent containing alkyl group may essentially include one or more alkyl groups such as methyl, ethyl, and propyl. The silane coupling agent containing alkyl group may include, but not be limited to, methyltrichlorosilane, methyltrimethoxysilane, methyltriethoxysilane, methyltributoxysilane, ethyltrimethoxysilane, ethyltriisopropoxysilane, ethyltributoxysilane, butyltrimethoxysilane, dimethyldiaminosilane, dimethyldichlorosilane, dimethyldiacetoxysilane, dimethyldimethoxysilane, dibutyldimethoxysilane, trimethylchlorosilane, methyltris(3-methyl-3-oxetanemethoxy)silane, and the like.

### (3) Silane Coupling Agent Containing Alkoxy Group

The silane coupling agent containing alkoxy group, as used herein, may increase complexation compatibility and the degree of reaction crosslinking of an organic component and an inorganic component of an organic-inorganic complex clear coating binder. The content of the silane coupling agent containing alkoxy group may range from about 10 to about 25 parts by weight based on the total weight of the hard coating layer. Herein, when the content of the silane coupling agent containing the alkoxy group is less than about 10 parts by weight or greater than about 25 parts by weight, complexation compatibility and the degree of reaction crosslinking of the organic component and the inorganic component of the organic-inorganic complex clear coating binder may be reduced.

The silane coupling agent containing alkoxy group may essentially include four or more alkoxy groups such as methoxy and ethoxy, and the silane coupling agent containing alkoxy group may include, but not be limited to, tetramethoxysilane, tetraethoxysilane, tetrapropoxysilane, tetraisopropoxysilane, hexaethoxydisilane, and the mixtures thereof.

### (4) Silica Sol

The silica sol, as used herein, may increase a abrasion resistance and strength of a coat film. The content of the silica sol may range from about 23 to about 40 parts by weight based on the total weight of the hard coating layer. Herein, when the content of the silica sol is less than about 23 parts by weight or greater than about 40 parts by weight, the abrasion resistance and strength of the coat film may be reduced.

### (5) Alcohol-Based Solvent

The alcohol-based solvent may be used to make the reaction of the organic-inorganic complex coating composition for hard coating uniform. The content of the alcohol-based solvent may range from about 15 to about 25 parts by weight based on the total weight of the hard coating layer. Herein, when the content of the alcohol-based solvent is less than about 15 parts by weight or greater than about 25 parts by weight, the reaction of the organic-inorganic complex coating composition for hard coating may not be uniformly performed.

The alcohol-based solvent may include, but not be limited to, methyl alcohol, ethyl alcohol, isopropyl alcohol, or alkoxy alcohol (2-methoxy ethanol, 2-ethoxy ethanol, 2-butoxy ethanol, and the like), and the mixtures thereof.

### (6) Water

Water, as used, herein may cause a hydrolysis reaction. The content of water may range from about 5 to about 15 parts by weight based on the total weight of the hard coating layer. Herein, when the content of water is less than about 5 parts by weight, the hydrolysis reaction of the silane coupling agent containing the alkyl group and the silane coupling agent containing the alkoxy group may not be completely performed and the uniform coating composition may not be manufactured. When the content of water is greater than about 15 parts by weight, reaction compatibility with the acryl-urethane silica compound may be reduced and the uniform organic-inorganic complex coating composition for hard coating may not be manufactured.

### (7) Acid Stabilizer

The acid stabilizer may be used to promote or allow an organic-inorganic complexation reaction to be performed. The content of the acid stabilizer may range from about 0.01 to about 0.3 parts by weight based on the total weight of the hard coating layer. Herein, when the content of the acid stabilizer is less than about 0.01 parts by weight, the organic-inorganic complexation reaction may not be completely performed, and when the content of the acid stabilizer is greater than about 0.3 parts by weight, gelation reaction of the binder may be promoted and storability may not be attained.

The acid stabilizer may include, but not be limited to, an organic acid such as a formic acid, an acetic acid, a propionic acid, a butyric acid, a lactic acid, a citric acid, and a fumaric acid, and an inorganic acid such as a phosphoric acid, a sulfuric acid, a hydrochloric acid, a nitric acid, a hydrofluoric acid, a chlorosulfonic acid, a p-toluenesulfonic acid, a trichloroacetic acid, a polyphosphoric acid, an iodic acid, an iodic anhydride, a perchloric acid, and the mixtures thereof.

According to various exemplary embodiments of the present invention, the polycarbonate article may be manufactured by coated with the coating paint composition, for example, with the primer layer and the hard coating layer, for glazing. In particular, the weather resistance and the abrasion resistance of the polycarbonate article may be substantially improved, storability may be improved, and workability may be excellent. In addition, various types of coating or painting methods such as flow coating, dip coating, and spray coating may be applied to the polycarbonate article. Moreover, since storability of the hard coating layer composition may be improved, cold storage may not be necessary, and thus a preservation time and a working time may be prolonged. In addition, since storability of the hard coating layer composition may be improved, the paint may be collected and the number of reuse may be increased to reduce primary cost.

### EXAMPLE

Hereinafter, the present invention will be described in more detail through the Examples. These Examples are only for illustrating the present invention, and it will be obvious to those skilled in the art that the scope of the present invention is not interpreted to be limited by these

### Preparation of Primer Layer

Hereinafter, among the coating paint compositions for polycarbonate glazing, the composition used in the primer layer is manufactured by the following method.

### (1) Manufacturing of Acryl Resin Compound

After the 2 L four-neck flask equipped with the thermometer, the condenser, and the agitator was installed in the heater, 314.0 g of 1-methoxy-2-propanol (hereinafter, referred to as PM), 198.8 g of methyl methacrylate (hereinafter, referred to as MMA), 0.4 g of the methacrylic acid (hereinafter, referred to as MAA), and 23.6 g of 2-hydroxyethyl methacrylate (hereinafter, referred to as 2-HEMA) were added, and heated to 75° C. while being agitated at the speed of 500 RPM. In addition, 2.2 g of VAZO-67® (DuPont, USA) that was the polymerization initiator was completely dissolved in 134.7 g of PM in the separate container, and then slowly added to the prepared flask. If addition was finished, 22.5 g of PM and 0.7 g of VAZO-67® were further completely dissolved in the separate container, and then added to completely react the unreacted acryl monomer and thus manufacture the acryl resin compound. Thereafter, while the reaction was cooled, 235.8 g of PM and 67.3 g of methyl ethyl ketone (hereinafter, referred to as MEK) were added to synthesize the final acryl resin compound solution.

### (2) Manufacturing of Paint Composition Used in Primer Layer

### Example

701.8 g of PM was added to the 2 L four-neck flask equipped with the thermometer, the condenser, and the agitator, and agitated at the speed of 500 RPM. Thereafter, 279.7 g of the acryl resin compound solution manufactured in the above was added, and continuously agitated. When the acryl resin compound solution was completely dissolved, 12.3 g of the piperidine oligomer-type UVA and 6.2 g of HALS (Tinuvin®400, BASF, USA) of the oxalanilide derivative were added and completely dissolved to manufacture the paint composition used in the primer layer.

### Comparative Example 1

701.8 g of PM was added to the 2 L four-neck flask equipped with the thermometer, the condenser, and the agitator, and agitated at the speed of 500 RPM. Thereafter, 279.7 g of the acryl resin compound solution manufactured in the above was added, and continuously agitated. If the acryl resin compound solution was completely dissolved, 6.2 g of the piperidine oligomer-type UVA and 3.1 g of HALS of the oxalanilide derivative were added and completely dissolved to manufacture the paint composition used in the primer layer.

### Comparative Example 2

701.8 g of PM was added to the 2 L four-neck flask equipped with the thermometer, the condenser, and the agitator, and agitated at the speed of 500 RPM. Thereafter, 279.7 g of the acryl resin compound solution manufactured in the above was added, and continuously agitated. If the acryl resin compound solution was completely dissolved, 12.3 g of UVA of the triazine derivative and 6.2 g of HALS of the oxalanilide derivative were added and completely dissolved to manufacture the paint composition used in the primer layer.

### Preparation of Hard Coating Layer

Next, among the coating paint compositions for polycarbonate glazing, the composition used in the hard coating layer is manufactured by the following method.

### 1. Synthesis of Resin

### (1) Manufacturing of Acryl-Urethane Silica Compound

Hereinafter, synthetic Examples where the acryl-urethane silica compound is manufactured by the manufacturing method of the present invention and Synthetic Comparative Examples where the acryl-silica compound is manufactured by another manufacturing method for comparison with the present invention will be described.

### Synthetic Example

After the 2 L four-neck flask equipped with the thermometer, the condenser, and the agitator was installed in the heater, 448.9 g of the propylene glycol monomethyl ether acetic acid (hereinafter, referred to as PMA) was added and heated to 105° C. Thereafter, 260.0 g of methyl methacrylate (hereinafter, referred to as MMA), 26.0 g of n-butyl acrylate (hereinafter, referred to as n-BA), 43.0 g of 2-hydroxyethyl methacrylate (hereinafter, referred to as 2-HEMA), and 9.0 g of VAZO-67® that was the thermopolymerization initiator were completely dissolved in the separate container, and then slowly added to the prepared flask while being agitated at the speed of 500 RPM to perform the acryl polymerization reaction. If addition was finished, 150.0 g of PMA and 1.0 g of VAZO-67® were further completely dissolved in the separate container, and then added to completely react the unreacted acryl monomer. Thereafter, the reaction temperature was decreased to 80° C., and 62.0 g of 3-isocyanatepropyltrimethoxysilane and 0.1 g of the organic metal catalyst were slowly added to perform the urethane reaction and thus synthesize the final acryl-urethane silica compound.

### Synthetic Comparative Example

After the 2 L four-neck flask equipped with the thermometer, the condenser, and the agitator was installed in the heater, 448.9 g of PMA was added and heated to 105° C. Thereafter, 260.0 g of MMA, 26.0 g of n-BA, 43.0 g of 2-HEMA, 62.0 g of 3-methacrylpropyltrimethoxysilane, and 9.0 g of VAZO-67® that was the thermopolymerization initiator were completely dissolved in the separate container, and then slowly added to the prepared flask while being agitated at the speed of 500 RPM to perform the acryl polymerization reaction. If addition was finished, 150.0 g of PMA and 1.0 g of VAZO-67® were further completely dissolved in the separate container, and then added to completely react the unreacted acryl monomer and thus synthesize the acryl silica compound.

### (2) Organic-Inorganic Complex Resin

### Example 1

In order to synthesize the organic-inorganic complex resin for hard coating, after the 2 L four-neck flask equipped with the thermometer, the condenser, and the agitator was installed in the heater, 180.0 g of 2-ethoxy ethanol (hereinafter, referred to as E-Cell (OXITENO, Brazil), 250.0 g of the acryl-urethane silica compound manufactured in the aforementioned Synthetic Example, 50 g of methyltrimethoxysilane (hereinafter, referred to as MTMS), 150.0 g of tetraethyl orthosilicate (hereinafter, referred to as TEOS), and 300.0 g of the silica sol were added, heated to 60° C., and agitated at the speed of 500 RPM. 69.0 g of water and 1.0 g of the hydrochloric acid were completely dissolved in the separate container, and then slowly added to be reacted for 6 hours, thus synthesizing the organic-inorganic complex resin for hard coating.

### Example 2

In order to synthesize the organic-inorganic complex resin for hard coating, after the 2 L four-neck flask equipped with the thermometer, the condenser, and the agitator was installed in the heater, 180.0 g of E-Cell, 320.0 g of the acryl-urethane silica compound manufactured in the aforementioned Synthetic Example, 70 g of MTMS, 110.0 g of TEOS, and 250 g of the silica sol were added, heated to 60° C., and agitated at the speed of 500 RPM. 69.0 g of water and 1.0 g of the hydrochloric acid were completely dissolved in the separate container, and then slowly added to be reacted for 6 hours, thus synthesizing the organic-inorganic complex resin for hard coating.

### Example 3

In order to synthesize the organic-inorganic complex resin for hard coating, after the 2 L four-neck flask equipped with the thermometer, the condenser, and the agitator was installed in the heater, 180.0 g of E-Cell, 260.0 g of the acryl-urethane silica compound manufactured in the aforementioned Synthetic Example, 60.0 g of MTMS, 130.0 g of TEOS, and 300.0 g of the silica sol were added, heated to 60° C., and agitated at the speed of 500 RPM. 69.0 g of water and 1.0 g of the hydrochloric acid were completely dissolved in the separate container, and then slowly added to be reacted for 6 hours, thus synthesizing the organic-inorganic complex resin for hard coating.

### Comparative Example 1

In order to synthesize the organic-inorganic complex resin for hard coating, after the 2 L four-neck flask equipped with the thermometer, the condenser, and the agitator was installed in the heater, 180.0 g of E-Cell, 210.0 g of the acryl-urethane silica compound manufactured in the aforementioned Synthetic Example, 70.0 g of MTMS, 150.0 g of TEOS, and 320.0 g of the silica sol were added, heated to 60° C., and agitated at the speed of 500 RPM. 69.0 g of water and 1.0 g of the hydrochloric acid were completely dissolved in the separate container, and then slowly added to be reacted for 6 hours, thus synthesizing the organic-inorganic complex resin for hard coating.

### Comparative Example 2

In order to synthesize the organic-inorganic complex resin for hard coating, after the 2 L four-neck flask equipped with the thermometer, the condenser, and the agitator was installed in the heater, 180.0 g of E-Cell, 370.0 g of the acryl-urethane silica compound manufactured in the aforementioned Synthetic Example, 30.0 g of MTMS, 100.0 g of TEOS, and 250 g of the silica sol were added, heated to 60° C., and agitated at the speed of 500 RPM. 69.0 g of water and 1.0 g of the hydrochloric acid were completely dissolved in the separate container, and then slowly added to be reacted for 6 hours, thus synthesizing the organic-inorganic complex resin for hard coating.

### Comparative Example 3

In order to synthesize the organic-inorganic complex resin for hard coating, after the 2 L four-neck flask equipped with the thermometer, the condenser, and the agitator was installed in the heater, 180.0 g of E-Cell, 250.0 g of the acryl-silica compound manufactured in the aforementioned Synthetic Comparative Example, 50 g of MTMS, 150.0 g of TEOS, and 300.0 g of the silica sol were added, heated to 60° C., and agitated at the speed of 500 RPM. 69.0 g of water and 1.0 g of the hydrochloric acid were completely dissolved in the separate container, and then slowly added to be reacted for 6 hours, thus synthesizing the organic-inorganic complex resin for hard coating.

2. Manufacturing of Paint Composition Used in Hard Coating Layer 500 g of the composition synthesized in the Examples and the Comparative Examples was diluted with 500 g of ethyl CELLOSOLVE® (OXITENO, Brazil), and 1.0 g of the leveling additive was added to manufacture the composition used in the final hard coating layer.

Next, the method of manufacturing the painted article by using the coating paint composition for polycarbonate glazing will be specifically reviewed. After the coating paint composition of the primer layer was applied by flow coating on the polycarbonate sheet and dried at 120° C. for 10 minutes, the coating paint composition of the hard coating layer was identically applied by flow coating thereon, and then cured at 130° C. for 60 minutes to obtain the painted article. In this case, as polycarbonate, MAKROLON® AG2677 manufactured by Bayer Corp., was used.

### Test Examples

Thereafter, performances of the painted article coated with the coating paint composition for polycarbonate glazing were evaluated by the following test method.

(1) Evaluation of appearance: It was observed by the naked eye whether there was no haze in the appearance of the coated film.
(2) Evaluation of adhesion property: After 10×10×2 mm cross cut, taping was performed by the tape to observe stripping.
(3) Evaluation of abrasion resistance: Abrasion was performed 500 times under the load of 500 g with the abrasion wheel of CS-10F [please provide description, product name or manufacturer name] by using the TABER abrasor (TABER Industries, Model 5135, USA) to measure the haze. The difference between the initial haze value and the haze value after the abrasion resistance test was calculated, and this value was represented by ΔHz₅₀₀. The case where ΔHz₅₀₀ was 10% or less was evaluated to be favorable.
(4) Evaluation of accelerated weatherability: After irradiation of 2500 KJ/m³ with the intensity of illumination of 0.75±0.02 W/(m² nm) at a wavelength of about 340 nm by using the WEATHER-O-METER (ATLAS, Model CI 4000, USA), the color change (ΔE) was measured by using the color-difference meter, and the case where ΔE was 2 or less was evaluated to be favorable.
(5) Evaluation of storability: The hard coating solution was contained in the 250 ml container, and stored at room temperature and in the oven at 60° C. to observe the viscosity change. At room temperature for 6 months and in the oven at 60° C. for 7 days, the test was performed.

The results of the aforementioned test method are described in the following Table 1.

TABLE 1

| | Coated | Coated | Coated | | | | | |
|---|---|---|---|---|---|---|---|---|
| | article 1 of | article 2 of | article 3 of | Comparative | Comparative | Comparative | Comparative | Comparative |
| | the present | the present | the present | painted | painted | painted | painted | painted |
| | invention | invention | invention | article 1 | article 2 | article 3 | article 4 | article 5 |
| Primer layer | Example | | | | | | Comparative | Comparative |
| | | | | | | | Example 1 | Example 2 |
| Hard coating | Example 1 | Example 2 | Example 3 | Comparative | Comparative | Comparative | Example 1 | Example 1 |
| layer | | | | Example 1 | Example 2 | Example 3 | | |
| Appearance | Transparent | Transparent | Transparent | Transparent | Haze | Transparent | Transparent | Haze |
| Adhesion | Favorable | Favorable | Favorable | Stripping | Favorable | Stripping | Favorable | Favorable |
| property | | | | | | | | |
| Abrasion | 4.0% | 4.1% | 3.8% | 28.9% | 9.4% | 47.4% | 4.2% | 4.0% |
| resistance (ΔHz₅₀₀) | | | | | | | | |
| Weather | 1.14 | 1.91 | 1.40 | — | — | — | 4.93 | 0.81 |
| resistance (ΔE) | | | | | | | | |
| Storability | Favorable | Favorable | Favorable | Poor | Poor | Poor | — | — |

According to the method of manufacturing the painted article by using the coating paint composition for polycarbonate glazing, the paint composition used in the primer layer was applied with Comparative Example 1, Comparative Example 2, and the Examples, and then the paint composition used in the hard coating layer was applied with Comparative Examples 1 to 3 and Examples 1 to 3 as described in Table 1. Thereafter, the table is arranged according to the aforementioned performance evaluation method.

It can be confirmed that in the painted articles using the coating paint composition for polycarbonate glazing of the present invention, that is, painted articles 1 to 3 of the present invention are suitable according to results of all evaluations. However, in comparative painted article 1, stripping occurred in terms of the adhesion property, the abrasion resistance was 28.9% which did not satisfy the evaluation standard, and storability was also poor. In comparative painted article 2, there was the haze in the appearance, and storability was poor. In comparative painted article 3, stripping occurred in terms of the adhesion property, the abrasion resistance was 47.4% which did not satisfy the evaluation standard, and storability was also poor. In comparative painted article 4, the weather resistance exceeded 2, which did not satisfy the performance evaluation standard. It was confirmed that in comparative painted article 5, the haze was generated in the appearance. As a result, it can be confirmed that painted articles 1 to 3 of the present invention satisfy the aforementioned performance evaluation standard.

According to the polycarbonate article coated with the coating paint composition for glazing, since the weather resistance and the abrasion resistance of the material are improved and workability is excellent, various types of painting methods such as flow coating, dip coating, and spray coating may be applied thereto. Further, since cold storage is not necessary, storability of the paint composition for hard coating may be improved, and since storability of the hard coating solution is improved, the paint is collected and the number of reuse is increased to reduce primary cost.

As described above, the present invention has been described in relation to specific embodiments of the present invention, but the embodiments are only illustration and the present invention is not limited thereto. Embodiments described may be changed or modified by those skilled in the art to which the present invention pertains without departing from the scope of the present invention, and various alterations and modifications are possible within the technical spirit of the present invention and the equivalent scope of the claims which will be described below.

What is claimed is:

1. A polycarbonate article, comprising:
a polycarbonate panel;
a primer layer applied on the panel; and
a hard coating layer applied on the primer layer.

2. The polycarbonate article of claim 1, wherein the primer layer comprises:
an acryl resin compound in an amount of about 25 to 33 parts by weight;
an UV stabilizer in an amount of about 1.5 to 3 parts by weight;
a leveling additive in an amount of about 0.1 to 0.3 parts by weight; and
a first organic solvent in an amount of about 65 to 75 parts by weight,
all the parts by weights based on the total weight of the primer layer.

3. The polycarbonate article of claim 2, wherein the UV stabilizer is one or more selected from the group consisting of TINUVIN® 400, HOSTAVIN® 3051, HOSTAVIN® 3206, HOSTAVIN® 3330, HOSTAVIN® 3052, HOSTAVIN® 3058, HOSTAVIN® N30, HOSTAVIN® PR-31, HOSTAVIN® TB 01, HOSTAVIN® TB 02, HOSTAVIN® AR08, HOSTAVIN® VSU 3206, HOSTAVIN® 3206, and HOSTAVIN® 3065.

4. The polycarbonate article of claim 2, wherein the leveling additive does not affect adhesion property between the primer layer and the hard coating layer, and is a silicon-based leveling additive or a non-silicon-based leveling additive.

5. The polycarbonate article of claim 2, wherein the acryl resin compound comprises: an acryl monomer not containing a hydroxy group in an amount of about 17 to 23 parts by weight; an acryl monomer containing a hydroxy group in an amount of about 2 to 5 parts by weight, an initiator in an amount of about 0.1 to 0.5 parts by weight, and a second organic solvent in an amount of about 70 to 80 parts by weight, all the parts by weights based on the total weight of a reaction mixture to produce the acryl resin compound.

6. The polycarbonate article of claim 5, wherein the acryl monomer not containing the hydroxy group comprises one or more acryl groups, and comprises one or more selected from the group consisting of a styrene monomer, methyl methacrylate, ethyl methacrylate, butyl methacrylate, methyl acrylate, ethyl acrylate, n-butyl acrylate, an acrylic acid, and a methacrylic acid.

7. The polycarbonate article of claim 5, wherein the acryl monomer containing the hydroxy group comprises one or more selected from the group consisting of 2-hydroxyethyl acrylate, 2-hydroethyl methacrylate, and 2-hydroxypropyl acrylate.

8. The polycarbonate article of claim 1, wherein the hard coating layer comprises: an acryl-urethane silica compound in an amount of about 23 to 36 parts by weight; a silane coupling agent containing alkyl group in an amount of about 3 to 10 parts by weight; a silane coupling agent containing alkoxy group in an amount of about 10 to 25 parts by weight; a silica sol in an amount of about 23 to 40 parts by weight; an alcohol-based solvent in an amount of about 15 to 25 parts by weight; water in an amount of about 5 to 15 parts by weight; and an acid stabilizer in an amount of about 0.01 to 0.3 parts by weight, all the parts by weights based on the total weight of the hard coating layer.

9. The polycarbonate article of claim 8, wherein the silane coupling agent containing alkyl group comprises one or more selected from the group consisting of a methyl group, an ethyl group, and a propyl group, and comprises any one selected from the group consisting of methyltrichlorosilane, methyltrimethoxysilane, methyltriethoxysilane, methyltributoxysilane, ethyltrimethoxysilane, ethyltriisopropoxysilane, ethyltributoxysilane, butyltrimethoxysilane, dimethyldiaminosilane, dimethyldichlorosilane, dimethyldiacetoxysilane, dimethyldimethoxysilane, dibutyldimethoxysilane, trimethylchlorosilane, and methyltris(3-methyl-3-oxetanemethoxy)silane.

10. The polycarbonate article of claim 8, wherein the silane coupling agent containing the alkoxy group comprises four or more alkoxy groups, and comprises one or more selected from the group consisting of tetramethoxysilane, tetraethoxysilane, tetrapropoxysilane, tetraisopropoxysilane, and hexaethoxydisilane.

11. The polycarbonate article of claim 8, wherein the alcohol-based solvent comprises one or more selected from the group consisting of methyl alcohol, ethyl alcohol, isopropyl alcohol, 2-methoxy ethanol, 2-ethoxy ethanol, and 2-butoxy ethanol.

12. The polycarbonate article of claim 8, wherein the acid stabilizer is an organic acid, an inorganic acid, or a mixture thereof.

13. The polycarbonate article of claim 12, wherein the organic acid comprises one or more selected from the group consisting of a formic acid, an acetic acid, a propionic acid, a butyric acid, a lactic acid, a citric acid, and a fumaric acid, and the inorganic acid comprises one or more selected from the group consisting of a phosphoric acid, a sulfuric acid, a hydrochloric acid, a nitric acid, a hydrofluoric acid, a chlorosulfonic acid, a p-toluenesulfonic acid, a trichloroacetic acid, a polyphosphoric acid, an iodic acid, an iodic anhydride, and a perchloric acid.

14. The polycarbonate article of claim 8, wherein the acryl-urethane silica compound comprises a silane coupling agent containing isocyanate in an amount of about 3 to 10 parts by weight, an acryl monomer containing a hydroxy group in an amount of about 3 to 10 parts by weight, an acryl monomer not containing a hydroxy group in an amount of about 20 to 30 parts by weight, an initiator in an amount of about 0.1 to 2 parts by weight, an organic metal catalyst in an amount of about 0.01 to 0.05 parts by weight, and a third organic solvent in an amount of about 50 to 60 parts by weight, all the parts by weights based on the total weight of the acryl-urethane silica compound.

15. The polycarbonate article of claim 14, wherein the silane coupling agent containing isocyanate comprises one or more selected from the group consisting of isocyanates, and includes one or more of 3-isocyanatepropyltrimethoxysilane, 3-isocyanatepropyltriethoxysilane, methoxytriisocyanatesilane, Y-isocyanatepropyltrimethoxysilane, and tetraisocyanatesilane.

16. The polycarbonate article of claim 14, wherein the acryl monomer containing the hydroxy group comprises one or more selected from the group consisting of 2-hydroxyethyl acrylate, 2-hydroethyl methacrylate, and 2-hydroxypropyl acrylate.

17. The polycarbonate article of claim 14, wherein the acryl monomer not containing the hydroxy group comprises one or more acryl groups, and comprises one or more selected from the group consisting of a styrene monomer, methyl methacrylate, ethyl methacrylate, butyl methacrylate, methyl acrylate, ethyl acrylate, n-butyl acrylate, an acrylic acid, and a methacrylic acid.

18. The polycarbonate article of claim 1, wherein the polycarbonate panel is transparent.

19. A vehicle part comprising a polycarbonate article of claim 1.
